(19) United States
(12) Patent Application Publication
(10) Pub. No.: US 2007/0011714 A1
(43) Pub. Date: Jan. 11, 2007

(54) Method of access using a television decoder and a decoder adapted to carry out the method

(76) Inventor: Paul Fellows, Cambridge (GB)

Correspondence Address: SILBER & FRIDMAN, 1037 ROUTE 46 EAST, SUITE 207, CLIFTON, NJ, 07013, US

(21) Appl. No.: 11/486,993

(22) Filed: Jul. 14, 2006

Related U.S. Application Data
(63) Continuation of application No. PCT/GB05/00123, filed on Jan. 16, 2004.

(30) Foreign Application Priority Data
Jan. 16, 2004 (GB) GB0400966.8

(51) Int. Cl. H04N 7/173

(52) U.S. Cl. 725/113; 725/100; 725/112

(57) ABSTRACT

A method of accessing services using a television decoder consists of the following steps. Initially storing a plurality of service locations is provided, so that services can be accessed in a data storage device. Each service location is associated with an internal channel number. The internal channel number corresponds to a desired service programmed in the decoder. The decoder obtains the service location associated with the internal channel number from the data storage device. Finally, the decoder accesses the service at the obtained service location.

This is a continuing application of PCT application PCT/GB2005/000123 filed Jan. 14, 2005 which claims priority of Great Britain patent application GB0400966.8 filed Jan. 16, 2004.

### FIELD OF THE INVENTION

This invention relates to a method of access to services using a television decoder and a television decoder adapted to carry out the method, and relates particularly to use of a set top box as a television decoder.

### BACKGROUND OF THE INVENTION

Set top boxes are electronic devices which receive television or other signals and convert these into a form suitable for display on a television. Commonly, set top boxes are used to allow digital television channels to be displayed on analogue televisions and to enable access to encrypted television channels. Typically a set top box receives a large number of digital television signals, some of which may be encrypted. The set top box converts one of the digital television channels selected by the user into a suitable form for display on a local television and provides the converted signal to the television for display. Typically the local television will be an analogue television and the converted signal provided by the set top box will be an analogue signal. The conversion process includes decryption of an encrypted television signal if necessary. A set top box can also be used to allow access to access controlled digital television channels by a digital television. In this case the converted signal will be a decoded or decrypted digital signal suitable for display by the digital television.

Operation of the set top box is usually controlled by the user using a conventional remote control hand set. Typical functions which can be controlled using the remote control hand set are switching on and off, and changing volume and the television channel displayed. Commonly the remote control hand set will control both the set top box and the associated television displaying the selected programming, but it is also possible to have separate remote controls for the set top box and television. Conventionally, in order to change the display of a desired television channel the user presses the number of the desired channel using a numerical keypad on the remote control device. The set top box responds to this number by providing the corresponding numbered television channel to the television for displaying.

The numerical keypad on the remote control device can also be used to select numbered options from an options screen menu system or to enter the corresponding numbers into an on line form. The use of numerical buttons on the remote control to select from a menu is commonly used to set television display parameters such as brightness, contrast etc and to allow interactive functions to be used.

Set top boxes are electronic devices generally having significant data processing capability. Accordingly, a number of arrangements have been proposed in which a set top box can access further services beyond television. For example, it has been suggested that a set top box should, in addition to providing access to television channels, provide access to the internet, video on demand systems, streaming music and multi-cast television. These services usually be provided for display to one or more local televisions associated with the set top box but in some circumstances alternative arrangements such as optionally providing streaming music to speakers which are not associated with a television may be desired.

Currently, in order to access these various services the action required from the user will vary depend upon the requirements of the particular service. Typically, television channels can be selected for display as discussed above by pressing the corresponding channel number on the remote control. In order to access a video on demand service the user typically needs to access a series of menus allowing then to choose the digital program they wish to watch. If the user wishes to look at a web page on the internet the user typically needs to access a menu, select an internet connection and then type in or select the URL (uniform resource locator) of the desired page. Similarly, in order to access streaming music and the internet the user would typically need to select an internet access and then surf to the streaming music web location and select to play it from that location.

Accordingly, although a set top box has the technical capability to allow the user to access and display through their television or other means a wide range of services, accessing the full range of services can be time consuming and inconvenient for the user. With known systems access to many services will require the user to navigate through a number of menus or type in information such as URL's and these menus and requirements will be different for different services.

Although the access requirements in specific applications may vary from the examples set out above, the problem remains that the procedures required for the user to access different services and resources are different.

### SUMMARY OF THE INVENTION

The present invention was made in an attempt to overcome this problem, at least in part. In a first aspect, this invention provides a method of accessing services using a television decoder comprising the steps of: storing a plurality of service locations at which services can be accessed in a data storage device, each service location being associated with an internal channel number, providing the identification of a desired service to the decoder; the decoder obtaining the service location associated with the internal channel number form the data storage device, and the decoder accessing the service at the obtained service location.

In a second aspect, this invention provides a television decoder comprising: a data storage device containing a plurality of service locations at which services can be accessed, each associated with a data input device arranged to receive an internal channel number, a processing device arranged to obtain the service location associated with the received internal channel number from the data storage device; and a service accessing device arranged to access the service available at the obtained location.

### DESCRIPTION OF THE PREFERRED EMBODIMENT

According to the present invention the set top box has a number of internal channels or functions each of which has a unique internal channel number. Each internal channel has an assigned action associated with it. When the user wishes to carry out the assigned action the user types in the internal channel number on the remote control hand set. The set top box responds to this number by carrying out the function assigned to the internal channel number.

The function associated with a specific internal channel can be any function which can be carried out by the set top box.

In known systems employing a remote control hand set to control a set top box the options permitted to the user are always a set of options or functions which the user can select between. These are generally a set of options which perform the same function but with a different parameter value. For example, when carrying out the usual procedure of changing the television channel the number entered on the remote control hand set selects the desired television channel number for display from the set of possible television channels.

In contrast, using the present invention each internal channel of the set top box can be assigned to carry out any function which the set top box is capable of performing. When the user wishes to access a particular service they simply input the internal channel number assigned to that service to the set top box using the remote control hand set. The set top box responds by recovering data identifying the service defined for the received internal channel number from memory and carrying out the necessary procedure to access and provide the service.

For example, if the service assigned to internal channel 1 is to display a multi-cast television channel, when the user selects internal channel 1 this multi-cast television channel will be displayed. Similarly, if the service assigned to internal channel 2 is display of a particular web page, when the user selects internal channel 2 the set top box will respond by connecting to the internet, accessing the chosen page and displaying the page.

Internal channels can be assigned to provide any service or access any resource which can be accessed by the set top box and which can be defined in a format which does not require selection or input.

Preferably, the assignment of services or resources to internal channels can be carried out by using a look up table stored in a memory within the set top box. Each entry in the look up table identifies an internal channel number and defines the service to be accessed and provided when that channel is selected.

There will be an entry in the look up table for every possible internal channel member, but some of these entries may be empty, having no defined corresponding service depending how many services the user assigns internal channel numbers.

Preferably the services to be accessed can be defined by a URL identifying to the set top box where the service can be accessed.

Examples of typical services and the URL prefixes used to identify them are shown in table 1. Table 1 shows standard URL prefixes which can be used by a set top box able to access terrestrial television channels, multi-cast television channels, satellite television channels, video on demand movies and web pages to define the generic type of the services.

Table 2 shows part of the contents of the look up table for an exemplary set top box. Table 2 shows the internal channel numbers and the assigned URL scheme and location identifiers which will be accessed by the set top box in response to the request for the corresponding internal channel number by the user.

The user may arbitrarily assign any accessible resource to any internal channel number. However, where relevant services are assigned internal channel numbers by a set top box provider it is preferred to group similar resources together in continuous internal channel number ranges so that they can be easily understood and remembered.

Such an arrangement may be preferred as an initial default setting which can be changed, and if necessary reverted to, by the user. For example, in a system having three digit internal channel numbers defining internal channel numbers 1 to 999, grouping as shown in table 2 could be used. In the example of table 2 internal channel numbers 200 and upwards access video news channels and web pages, internal channel numbers 300 and upwards access videos on demand movies, internal channel numbers 400 and upwards access sports channels and web pages, internal channel numbers 700 and upwards access games, web pages and internal channel numbers 900 and upwards access gambling pages and web sites.

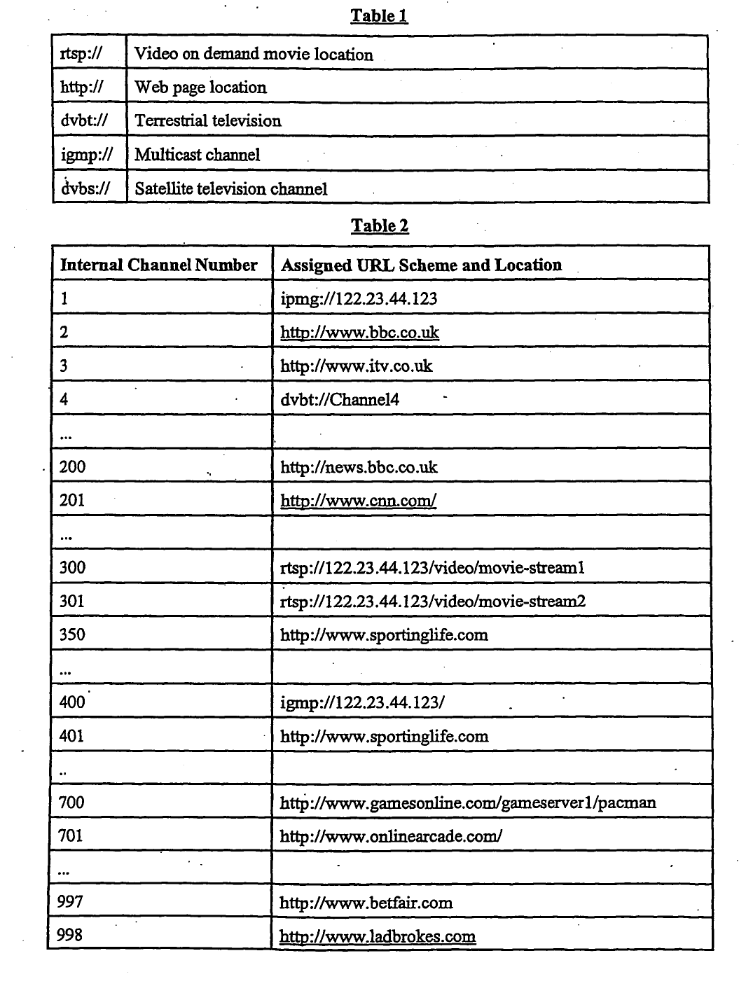

There is no requirement that the services requested by a user and accessed by the set top box in response to a particular internal channel number should be television stations and web pages only as shown in FIG. 2. The internal channel numbers could also be used to access online games directly, internet gambling sites or internet radio channels where music is streamed over the internet connection. Further, there is no requirement that the services requested and accessed by an internal channel number should be remote services. Internal channel numbers can be assigned to access locally held games or media stored locally on the users own devices, provided that these are accessible using the set top box.

The invention provides a number of advantages. The user can access desired services simply by selecting the internal channel number assigned to the service instead of having to go through the usual process of manually accessing the service. This is simpler and quicker for the user even when the user fully understands and is familiar with the procedure to manually access the service. Further, the invention allows the user to quickly and easily access a service which has been accessed in the past even when the user is unfamiliar with how to access the service and has only been able to access it by carefully following step by step instructions or by chance. Further, if the set top box is provided with service locations already recorded the user can access services using the appropriate internal channel numbers without having to understand how to manually access the services at all.

Thus, the invention allows simplified access to services located in different places which may be local or on the internet allowing the user to have a seamless multi-media experience.

Another advantage of the invention is that when the set top box provider makes new or improved services available the location information for these services can be assigned internal channel numbers and the necessary location information recorded in the look up table remotely by the set top box provider. The user can then be notified of the existence of the new and improved services and the relevant internal channel numbers on which the services can be accessed. The simplicity of then accessing the new services will significantly increase user interest and uptake of new services. Of course it is not essential that the new or improved services made available are provided by the set top box provider directly. However, in practice it will normally be the case that any service provider wishing to have new or improved services remotely assigned internal channel numbers and recorded in this way will require the assistance or permission of the set top box provider because remote access to the set top box will normally be controlled by passwords or similar arrangements for data security purposes.

Preferably, a user will be able to assign an internal channel number to a service location by accessing the source location and then instructing the set top box that the current source location is to be assigned an internal channel number. Such an instruction could be made using a specific function key or by inputting a specific number which is not an internal channel number. For example, in the example above where the internal channel numbers are arranged 1 to 999 the function of assigning the currently accessed service an internal channel number could be selected by inputting number 0. Alternatively, a number within the normal internal channel number range could be assigned to provide this function rather than being an internal channel number accessing a service. Preferably this number should be an easily remembered one such as 900. In practice it is expected that this would be the most common way to assign internal channel numbers to new services by a user. However, it is preferred also to allow the user to manually input the URL scheme and location of a desired service to be assigned an internal channel number.

Optionally, the set top box can have one or more internal channel numbers assigned to access emergency assistance or carers. For example the internal channel number corresponding to the local emergency services telephone number, 999 in the UK, or 911 in the USA, could be arranged to access an emergency services web page allowing a user to alert police, fire, ambulance or other emergency services. Another option would be for an easily remembered internal channel number to contact an alarm monitoring company for users having a served burglar alarm or a warden for users in sheltered accommodation.

Optionally, the set top box can be arranged to automatically record the URL for accessed services and to assign them internal channel numbers following predetermined rules for user selected preferences. For example each time the accessed service is changed or the set top box switched off the URL of the last service accessed could be recorded as a specified internal channel number. The user can then use this internal channel number as a “return to the previous service” function.

Other arrangements are possible, for example the set top box could adaptively update a group of internal channel numbers to contain the URL of the most often accessed service or a number of most recently accessed services.

In table 1 entries from look up tables for an exemplary set top box in the invention are shown. Advantageously, the look up table can include a third field for each entry giving the identity of the accessed service in terms comprehensible to the user. This title could be a television channel such as Channel 4 or BBC1. Further, it is preferred that the set top box should be able to display on request some or all internal channel numbers and the corresponding titles for review and/or editing by the user on request. Optionally this display can also display the URL's of the services.

Further, it is preferred that the set top box include the ability to assign an already recorded service URL a new internal channel number so that the user can group services together as desired.

In the description above the use of internal channel numbers to access services is discussed. Commonly these services will be services allowing television or music programming to be accessed and displayed. However, services may also be web pages or menus allowing the services to be accessed to be selected. For example, an internal channel number could have an assigned URL taking the user directly to the start of a particular movie from a video on demand service. Alternatively, an internal channel number could have a URL taking the user to a movie selection screen of the video on demand service provider. This still provides the advantage of allowing the user to avoid any intermediate steps required to access the screen.

An example of use of the invention is as follows.

A user sitting at home watching a terrestrial television programme via their set top box, perhaps BBC One. If the user decides that they want to listen to an internet radio station, traditionally, they would have to launch a web browser and connect to the website which hosts the radio station. In this example, they have already assigned the streaming radio to channel 8 on their set top box and therefore they would only need to press 8 and the action of “Go to” the specified URL scheme and location would be executed.

If, after listening to the radio for a while the user decides to see what odds are available for the football match later that day, they can select channel number 998 on their remote control handset and the set top box would display http://www.ladbrokes.com because that is what internal channel 998 is assigned as in the user's choices.

Finally, before the football match the user wants to watch a video on demand movie which is on a movie service somewhere on the internet or a local server. Again, selecting channel number 300 would link directly to a video on demand server and start the movie which is also passed as a parameter in the action string of the URL.

In the above description control of a set top box and selection of internal channel numbers using a remote control hand set is referred to. This is the most common and convenient method of controlling a set top box. However, use of a hand set is not essential and other methods of control and inputting internal channel numbers such as a key pad on or connected to the set top box, for example a wired or wireless keyboard, could be used if desired.

What is claimed is:

1. A method of accessing services using a television decoder comprising the steps of:
storing a plurality of service locations at which services can be accessed in a data storage device, each service location being associated with an internal channel number, providing the internal channel number of a desired service to the decoder;
the decoder obtaining the service location associated with the internal channel number from the data storage device, and
the decoder accessing the service at the obtained service location.

2. A method according to claim 1, wherein the data storage device is a memory device.

3. A method according to claim 1, wherein the television decoder is a set top box.

4. A method according to claim 1, wherein in which the service location is a URL.

5. A method according to claim 1, wherein the internal channel numbers and service location are stored in a look up table.

6. A method according to claim 1, wherein the identifier is provided to the decoder from a remote control hand set.

7. A television decoder comprising:
a data storage device containing a plurality of service locations at which services can be accessed, each associated with an internal channel number;
a data input device arranged to received an internal channel number,
a processing device arranged to obtain the service location associated with the received internal channel number from the data storage device; and
a service accessing device arranged to access the service available at the obtained location.

8. A decoder according to claim 7 wherein the data storage device is a memory device.

9. A decoder according to claim 7, wherein the decoder is a set top box.

10. A decoder according to claims 7, wherein the service location is a URL.

11. A decoder according to claim 10, wherein the internal channel numbers and service locations are stored as a look up table.

12. A decoder according to claim 7, wherein the data input device is a receiver adapted to receive the identifier from a remote control hand set.
